(19) United States
(12) Patent Application Publication
(10) Pub. No.: US 2003/0142367 A1
(43) Pub. Date: Jul. 31, 2003

(54) Image reader

(75) Inventor: Mitsunari Ito, Shizuoka (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/347,881

(22) Filed: Jan. 22, 2003

(30) Foreign Application Priority Data
Jan. 31, 2002 (JP) 024217/2002 (PAT.

(51) Int. Cl. H04N 1/04; H04N 1/40

(52) U.S. Cl. 358/461; 358/474

(57) ABSTRACT

An image reader including an optical reading section that reads reflected light from a light source; a reference density member that is fixedly installed at an original document reading position, and that is read by the optical reading section for acquiring data for correcting the light amount of the light source; a correction coefficient setting section that sets a correction coefficient for every read page, based on reference data obtained by reading the reference density member in advance, and read data obtained by reading the reference density member during each time interval between two successive pages of the original documents fed to the original document reading position one page after another; and a light amount correction section that performs light amount correction according to the above-described correction coefficient corresponding a read page, for each of the pages of the original document images read by the optical reading section.

### BACKGROUND OF THE INVENTION

1. Field of the Invention

The present invention relates to an image reader such as a scanner, and the like.

2. Description of the Related Art

In an image reader capable of continuously reading an original document by using an image sensor (CCD), which electronically converts reflected light from a light source such as a fluorescent lamp, image correction such as shading correction and light amount correction of the light source are frequently performed in order to improve the image quality of a read image.

In the shading correction, variations for every pixel in the image sensor and variations in the light amount of a light source due to the luminous intensity distribution characteristic of the light source are corrected, while in the correction of light amount of the light source, variations of the light source due to the change of the light source with time are corrected. For example, when a fluorescent lamp is used as the light source, the light amount varies during the course of continuous reading, since the light source change with time is large. These variations of light amount manifest themselves in the form of output variations of the image sensor. Specifically, as the light amount decreases, the dynamic range when an analog output from the image sensor is A/D converted decreases, (i.e., the S/N ratio degrades), so that the image quality deteriorates (i.e., the number of gradation bits decreases), and therefore, it is necessary to perform light amount correction to correct variations in light amount with time.

As examples of conventional image correcting methods for image readers in which such image correction is performed, the following methods are known.

(1) As disclosed in Japanese Patent Laid-Open No. 64-24564, a temperature sensor is provided in the vicinity of an image sensor, and the output value is corrected based on the detected temperature and the relationship between the preset temperature and the output voltage at a dark time.

(2) As disclosed in Japanese Patent Laid-Open No. 60-113575, a light amount detecting means is provided in the vicinity of a light source, for use in correcting the light amount.

(3) In Japanese Patent Publication No. 3-63696, an image reader having a second mode is disclosed in which data in an original document are read by moving the original document with a conventional scanning optical system maintained at a standstill. In this mode, reflected light from a first reference white plate provided above a platen glass and that from a second reference white plate provided outside the region where moving original documents are read as occasion requires, are read by an image sensor, thereby comprehensively performing PRNU (Photo Response Non-Uniformity) correction, DSNU (Dark Signal Non-Uniformity) correction, and the correction of overall image signals including the correction of the light amount reduction at the end portion in an optical system and gain setting.

(4) As disclosed in Japanese Patent Laid-Open No. 10-257313, an image sensor having a portion for reading an image and a portion for reading a reference white plate are used, and changes in the light amount and the color of a light source are detected by the output of the image sensor portion for reading the reference white plate, thereby correcting the output of the aforementioned image sensor portion for reading an image.

(5) An image reader equipped with an automatic document feeder (ADF) that includes a first reference white plate provided below the platen glass, and a second reference white plate provided at the openable/closable document cover side and placed in the region where moving original documents are read, performs shading correction as occasion requires, by using the second reference white plate during each time interval between two successive sheets of original documents.

(6) In Japanese Patent Laid-Open No. 2001-298592, a reference white plate for reading data for light amount correction is provided so as to be inserted and removed into/from the original document reading position on a platen glass, and light amount correction is performed based on data obtained by reading the aforementioned reference white plate during each time interval between two successive paper sheets of original documents succeedingly fed.

However, the above-described conventional image readers involve the following problems.

The conventional examples (1), (2) have a drawback of incurring a high cost caused by the increase in required installation space for separately providing means for detecting an environment temperature or a light amount, and for the increase in cost for the number of components.

As in the conventional example (3), a recent image sensor has a plurality of channels such as odd-numbered pixels and even-numbered pixels in order to achieve high-speed reading and high resolution. Therefore, if a setting is made for every channel (signal line) as in the case of PRNU or DSNU, variations in the density between the odd-numbered pixels and even-numbered pixels occur irrespective of the light amount of a light source. This raises a problem of reducing the number of gradation bits. Furthermore, the end portion of the image sensor, which is located outside the reading range in the main scanning direction, is an unstable factor in that it reduces the light amount according to the cosine fourth law of lens. This could inhibit the light amount correction from being accurately implemented.

The conventional example (4) requires a specific temperature sensor, thereby causing a high cost.

In the case of an apparatus such as the conventional example (5), when an original document is read after being placed on a platen glass, the original document must normally be read even if the document cover is open (because, when a thick book is read, images are read with the document cover left opened), and hence, the first reference white plate is usually installed at a position allowing reading irrespective of whether the document cover is opened or closed. Therefore, when the first and second reference white plates are read, the optical path lengths from a light source to an image sensor are different between these plates, and this difference brings about variations in the output of the image sensor. Moreover, the output variations cause a deviation from the white reference level. This raises a problem in that accurate shading correction may become impossible, or that a temperature difference occurs between flat-bed reading and ADF reading.

The conventional example (6) requires driving means that drives the reference white plate to insert and remove it into/from the original document reading position, resulting in a complicated apparatus. This makes it difficult to reduce the size of the apparatus and also increases the cost.

### SUMMARY OF THE INVENTION

Accordingly, it is an object of the present invention to provide an image reader that has a simple construction without additional undue expense, and is capable of obtaining superior read images even if changes occur in the light source during continuous reading.

In order to achieve the above-described object, the present invention, in one embodiment, provides an image reader that includes an optical reading section that reads reflected light from a light source. A first reference density member is installed outside an original document reading position, and is read by the optical reading section for acquiring data for correcting shading. A second reference density member is fixedly installed at the original document reading position so as not to block the optical path between the light source and the conveyance path of original documents, and that member is read by the optical reading section for acquiring data for correcting the light amount of the light source. Also, a first correction coefficient setting section is provided to set a first correction coefficient, based on first reference data obtained by reading the first reference density member in advance, and read data obtained by reading the first reference density member at startup of the original document reading. A second correction coefficient setting section is provided to set a second correction coefficient for every read page, based on second reference data obtained by reading the second reference density member in advance, and read data obtained by reading the second reference density member during each time interval between two successive pages of the original documents fed to the reading position one page after another while the original documents are read. Finally, a correction section is provided to perform shading correction according to the first correction coefficient, as well as to perform light amount correction according to the second correction coefficient corresponding to a read page, for each of the pages of the original document image read by the optical reading section.

With these simple arrangements, it is possible to obtain a superior read image even if changes occur in the light output during continuous reading.

Other objects and features of the present invention will be apparent from the following descriptions and the accompanying drawings, in which like reference characters designate the same or similar parts.

### BRIEF DESCRIPTION OF THE DRAWINGS

FIG. 1 is a block diagram of a circuit for an image reader according to an embodiment of the present invention.

FIGS. 2A and 2B are representations of the construction of the image reader according to the present embodiment.

FIG. 3 is a flowchart showing the details of the image reading operations of the present embodiment.

FIG. 4 is a diagram showing the relationship between the change of the light amount with time and the light amount correction coefficient in the present embodiment.

### DESCRIPTION OF THE PREFERRED EMBODIMENTS

Hereinafter, an embodiment according to the present invention will be described with reference to the accompanying drawings.

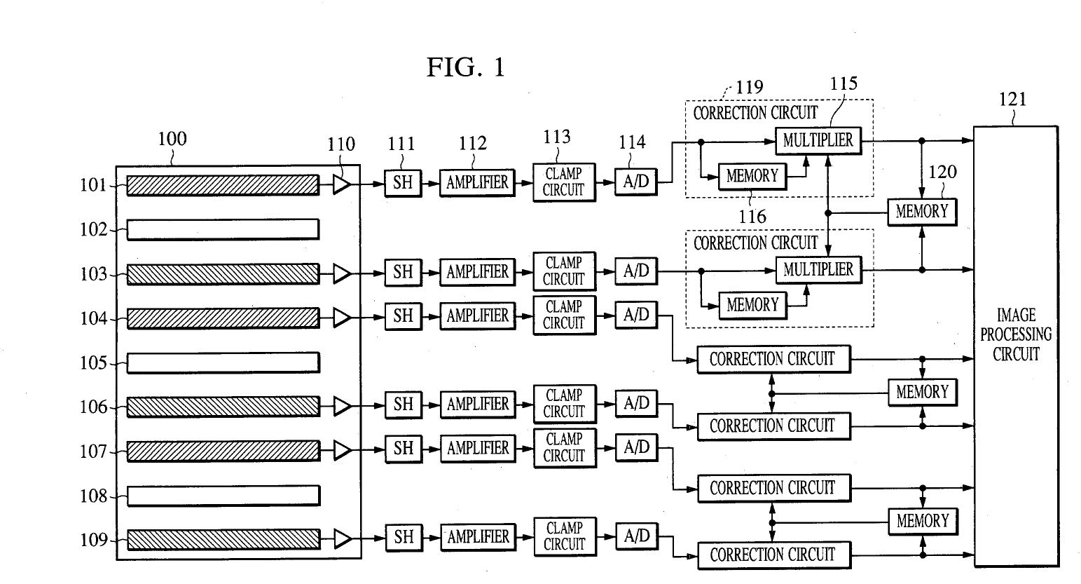

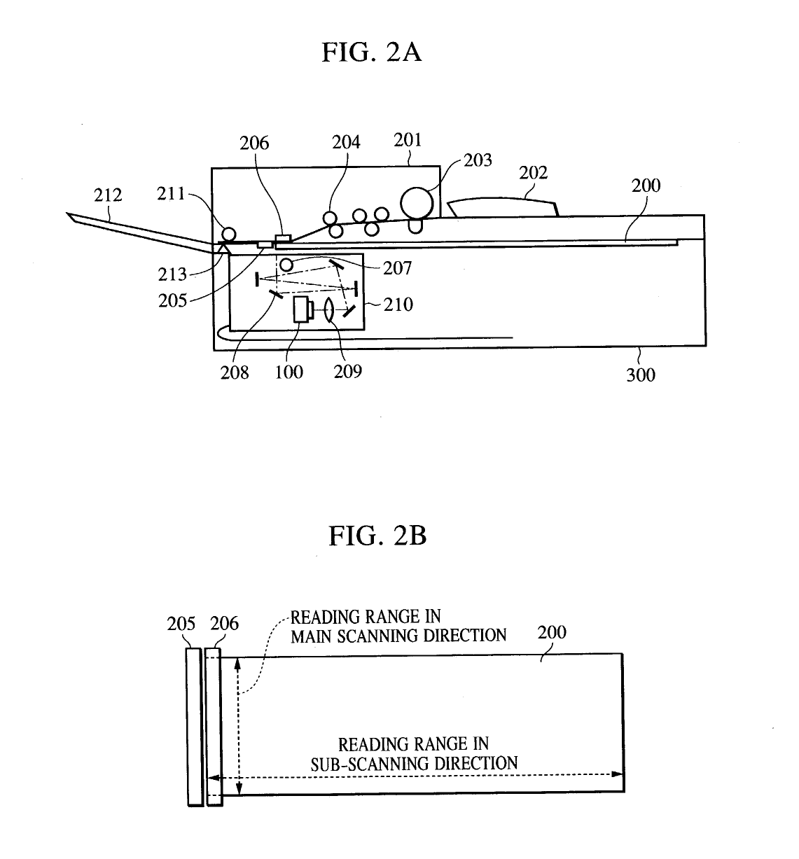

FIG. 1 is a block diagram of a circuit for an image reader according to the embodiment of the present invention, and FIGS. 2A and 2B are representations of the construction of the image reader according to this embodiment, in which FIG. 2A is a sectional view thereof, and FIG. 2B is a top plan view thereof. <Constructions of Main Members in the Image Reader>

Referring to FIG. 2A and 2B, a contact glass 200 is provided on the top surface of the body 300 of this image reader, and an optical reading unit 210 movable in the sub-scanning direction of the contact glass 200 is accommodated within the body 300. Above the body 300, there is provided an auto document feeder (ADF) 201 that automatically conveys original documents to a document reading position (located below a second reference white plate 206 described later).

The optical reading unit 210 comprises an irradiation light source 207, reflecting mirrors 208, a condenser lens 209, and a color CCD (Charge-Coupled Device) image sensor 100. The color CCD image sensor 100 is a photoelectric conversion device that separates reflected light from the irradiation light source 207 into a plurality of channels, and that photoelectrically converts the reflected light. The optical reading unit 210 is controlled by a controller (not shown) so that, when reading an original document placed on the contact glass 200, the optical reading unit 210 moves in the sub-scanning direction, and that, when reading the original document while the controller causes the ADF 201 to convey the original document, the optical reading unit 210 reads the fed original document in a state stationary at the original document reading position.

Specifically, when original documents are continuously read using the ADF 201, the read surface of each of the original documents is set face-down in a paper feed tray 202. Next, the reading unit 210 is moved from a home position 213 to the above-described original document reading position, and after one of the original documents stacked in the paper feed tray 202 has been picked up by a pickup roller 203, the original document is conveyed past the original document reading position by paper feed rollers 204. Light is applied to the original document by the irradiation light source 207, and the reflected light thereof is read by the color CCD image sensor 100. Thereafter, the original document is discharged to a paper discharge tray 212 by a paper discharge roller 211.

When the paper feed tray 202 is still in a state loaded with original documents, continuous reading is performed with the original documents picked up one after another. During reading, light from the irradiation light source 207 is applied to the original document, and via reflecting mirrors 208, the reflected light is converged by a condenser lens 209 to form an image on the color CCD image sensor 100. Then, the formed image is photoelectrically converted by the color CCD image sensor 100, thereby obtaining image information in the main scanning direction.

The above-described original document reading position, where conveyed original documents are read, is set to be at an end position of the contact glass 200, the end position being located within the reading range in the sub-scanning direction. At this original document reading position, the second reference white plate 206 (second reference density member) is provided for acquiring data for correcting the light amount of the light source 207. Plate 206 is fixed on the surface of the contact glass 200 with a space such as to allow the passage of a conveyed original document, interposed therebetween.

Also, a first reference white plate 205 (first reference density member) for shading correction is fixed on a position outside the reading range in the sub-scanning direction, the position being located outside the end portion of the contact glass 200.

<Main Electrical Construction of the Image Reader>

As shown in FIG. 1, the image reader according to this embodiment has sample hold circuits (SH) 111, amplifiers 112, clamp circuits 113, A/D converters 114, and correction circuits 119 any of which are as many as channels of the color CCD image sensor 100.

The color CCD image sensor 100 comprises photodiodes 102, 105, and 108 that have filters of colors R(red), G(green), and B(blue), respectively; and transfer registers 101, 103, 104, 106, 107, and 109 that transfer the electric charges of the photodiodes by separating the electric charges into those of odd-numbered pixels and those of even-numbered pixels; and output amplifiers 110 for these transfer registers.

Here, reference numeral 101 denotes the odd-numbered pixel transfer register for R, reference numeral 102 denotes the photodiode for R, reference numeral 103 denotes the even-numbered pixel transfer register for R, reference numeral 104 denotes the odd-numbered pixel transfer register for G, reference numeral 105 denotes the photodiode for G, reference numeral 106 denotes the even-numbered pixel transfer register for G, reference numeral 107 denotes the odd-numbered pixel transfer register for B, reference numeral 108 denotes the photodiode for B, and reference numeral 109 denotes the even-numbered pixel transfer register for B.

Each output from the color CCD image sensor 100 is freed from carrier noises in the sample hold circuit 111, and after the range of the output has been adjusted in the amplifier 112 and the clamp circuit 113, the output is converted into digital data by the A/D converter 114.

The original document images converted into the digital data by the A/D converters 114 are subjected to shading correction described later, in the correction circuits 119 for each of the channels of R, G, and B, and further subjected to light amount correction described later.

<Details of Image Reading Operation in This Embodiment>

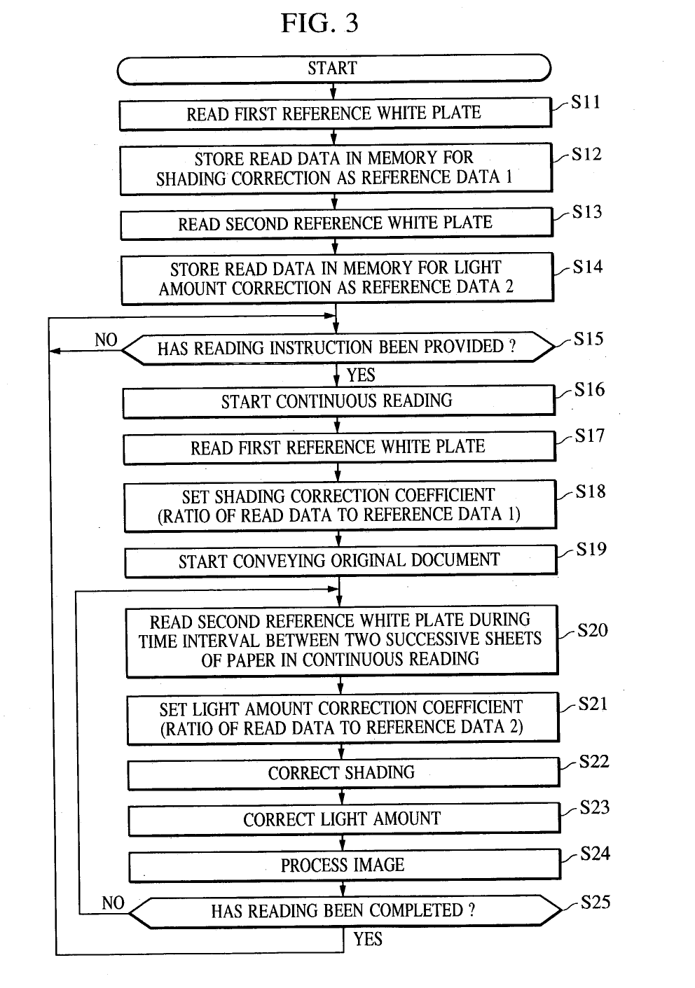

Next, details of the image reading operation in this embodiment will be described with reference to a flowchart shown in FIG. 3.

At initialization, the first reference white plate 205 is read (step S11), and data for shading correction obtained by reading the first reference white plate 205 is stored in the memory 116 as a reference data 1, for each of the channels of R, G, and B converted into digital data by the A/D converters 114 (step S12). Specifically, the read data are stored by separating them into a main scanning reference white register for R (odd), a main scanning reference white register for R (even), a main scanning reference white register for G (odd), a main scanning reference white register for G (even), a main scanning reference white register for B (odd), and a main scanning reference white register for B (even). Here, with regard to stored data, it is preferable that the average value of the data obtained by reading a plurality of lines be stored.

Simultaneously, in order to monitor the change of the light source with time, a plurality of pixels of the second reference white plate 206 are read (step S13), and the mean value of data on odd-numbered pixel channels and even-numbered pixel channels is collectively calculated for every color. Then, the obtained data are stored into the memory 120 for light amount correction as a reference data 2 for every color (step S14). Specifically, these data are stored by separating them into three registers: a sub-scanning reference white register for R (common to odd and even), a sub-scanning reference white register for G (common to odd and even), and a sub-scanning reference white register for B (common to odd and even). Since R, G, and B have the same constitution although they are different in color, red signals alone are representatively described. The acquisition of the above-described reference data 1 and 2 may be made upon power-up or upon factory shipment.

Next, upon receipt of a continuous reading instruction from the controller (not shown) in step S15, the image reader starts continuous reading of original documents (step S16). At start-up of the continuous reading operation, the first reference white plate 205 is read (step S17), thereby setting a shading correction coefficient. Specifically, the ratios of the read data (the main scanning white register for R (odd) and the main scanning white register for R (even)) obtained by reading the first reference white plate 205 with respect to preset values of the above-described reference data 1 (the main scanning reference white register for R (odd) and the main scanning reference white register for R (even)) are calculated as the shading correction coefficients based on the following respective expressions (step S18).

Shading correction coefficient (odd)=[main scanning white register for R (odd)]÷[main scanning reference white register for R (odd)]

Shading correction coefficient (even)=[main scanning white register for R (even)]÷[main scanning reference white register for R (even)]

When the shading correction coefficient is calculated and set in this manner, conveyance of one of the original documents stacked in the paper feed tray 202 to the original document reading position is started (step S19).

At the original document reading position, an original document is read. Furthermore, during a time interval between two successive pages of the original documents, the second reference white plate 206 is read (step S20), and thereby a light amount correction coefficient for each read page is set. Specifically, the ratio of the read data (the sub-scanning white register for R (common to odd and even) obtained by reading the second reference white plate 206 with respect to a preset value of the above-described reference data 2 (the sub-scanning reference white register for R (common to odd and even) is calculated as the light amount correction coefficient based on the following expression (step S21).

Light amount correction coefficient (odd/even)=[sub-scanning white register for R]÷[sub-scanning reference white register for R]

Next, shading correction is performed by multiplying the original document digital data that has been read for each of the channels (odd-numbered and even-numbered pixels) by the above light amount correction coefficient using a multiplier 115 (step S22). Specifically, the correction of the luminous intensity distribution characteristic of the light source 207, the correction of respective differences among the sample hold circuits 111, the amplifiers 112, and the clamp circuits 113, as well as the sensitivity correction of the color CCD image sensor 100 for each of odd-numbered and even-numbered pixels are performed.

Moreover, a light amount correction is performed with respect to the original document images subjected to the shading correction (step S23). Specifically, the light amount correction of the light source 207 is performed by multiplying the original document digital data that has been read for each of the colors (R, G, and B) by the above light amount correction coefficient.

The data subjected to the shading correction and the light amount correction in the correction circuits 119 is subjected to various image processings such as γ correction and the like in an image processing circuit 121 (step S24).

The processings of the above-described steps S20 to S24 are repeated until continuous reading has been completed in read page units. Upon completion of the continuous reading, the processing returns to step 15, and a continuous reading instruction is awaited (step S25).

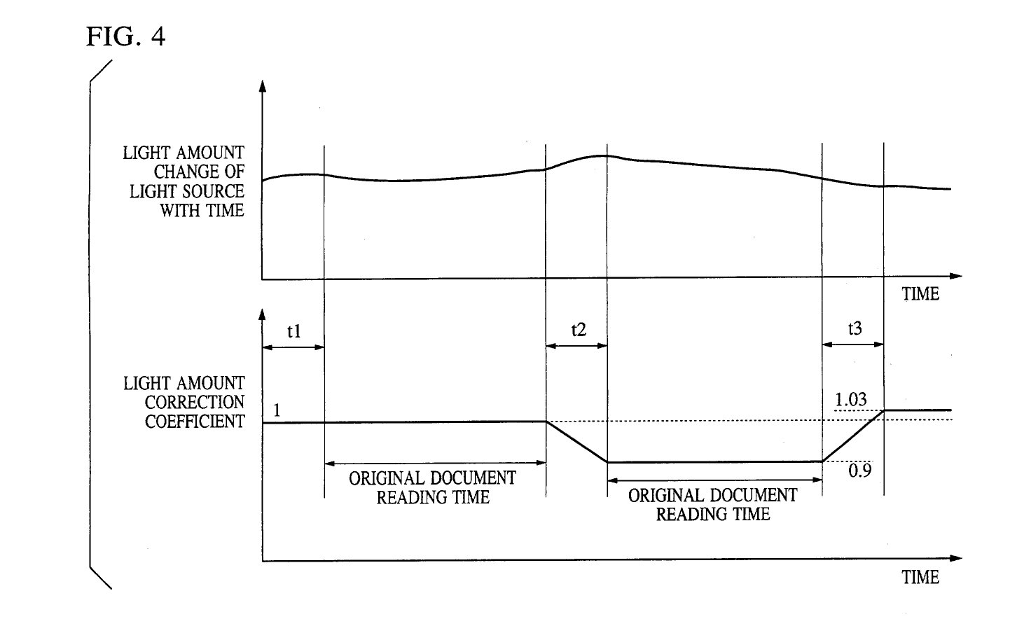

FIG. 4 is a diagram showing the relationship between the change of the light amount with time and the light amount correction coefficient.

Referring to FIG. 4, the reading of a first original document provides a reference (t1), and therefore, the light amount correction coefficient at this time is 1, and the light amount correction coefficient is kept at 1 until the reading of the first original document has been completed. During the time interval between the first sheet and a second sheet of the original documents, the second reference white plate 206 is read (t2). At this time, the light amount has become 1.1 times as high as the reference, and hence, the light amount correction coefficient is set to 0.9, which is the reciprocal number of 1.1, and the light amount is kept at this value until the second original document has been read. Succeedingly, the light amount correction coefficient is similarly updated for every read page.

As described above, in this embodiment, there are provided the first reference white plate 205 provided outside the sub-scanning region at the reading position where moving original documents are continuously read, and the second reference white plate 206 provided at the reading position where moving original documents are continuously read using the ADF. Using the color CCD image sensor 100 that reads reflected light from the light source 207, the shading correction is performed, such as sensitivity correction, for every pixel, according to the changing amount of the reference data 1 obtained by reading the reflected light from the first reference white plate 205 at the initialization and that of the read data obtained by reading the reflected light from the first reference white plate 205 at the start-up of continuous reading. Thereupon, the light amount correction is performed by setting a correction coefficient for each of the colors R, G, and B, or a correction coefficient common to R, G, and B, for every read page, according to the changing amount of the reference data 2 obtained by reading the reflected light from the second reference white plate 205 at the initialization and that of the read data obtained by reading the reflected light from the second reference white plate 206 during each time interval between two successive sheets of paper in continuous reading. Thereby, it is possible to always obtain superior read images while securing high-speed and high-resolution reading even if changes of the light source occur with time.

Meanwhile, the correction coefficient used for light amount correction is determined for every color, but a coefficient common to R, G, and B may be used as a correction coefficient for light amount correction. In this case, by using any one of odd-numbered pixel channels and even-numbered pixel channels of R, G, and B, reading is performed between a time interval between two successive sheets of paper. The mean value of the plural pixels thereof is stored into the memory 120 for light amount correction. Alternatively, another method may be used in which only one color is taken out of R, G, and B, and after equal number of odd-numbered pixels and even-numbered pixels of the taken-out color have been added, the mean value thereof is calculated, and in which the mean value is stored into the memory for light amount correction 120.

Storing a program according to the above-described flowchart shown in FIG. 3 into a storage device in the controller (not shown) enables the implementation of the above-described controlling method.

The present invention is not limited to the above-described embodiment. The invention can be applied to a system comprising a plurality of apparatuses or an apparatus comprising one device. The functions of the above-described embodiment can also be accomplished by a method in which a storage medium storing program codes of software for implementing the functions of the above-described embodiment is supplied to a system or an apparatus, and in which a computer (alternatively a CPU (Central Processing Unit) or an MPU (Microprocessor Unit)) reads out the program codes stored in the storage medium and executes them.

In this case, the program codes themselves read out from the storage medium implement the functions of the above-described embodiment. Hence, the storage medium in which the program codes have been stored is also incorporated in the scope of the invention. As a storage medium for supplying the program codes, for example, a floppy® disk, a hard disk, an optical disk, a magneto-optic disk, a CD-ROM, a CD-R, a magnetic tape, a non-volatile memory card, a ROM, or the like can be used. Also, the invention incorporates not only a case where a computer executes the read-out program codes, thereby implementing the functions of the above-mentioned embodiment, but also a case where, based on instructions of the program codes, the OS or the like that is operating on the computer executes a part or all of the actual processings, thereby implementing the functions of the above-described embodiment.

Furthermore, the invention also incorporates a case where the program codes read out from the storage medium are written into a memory provided for a function expanding board inserted in a computer or a function expanding unit connected to a computer. Then, based on instructions of subsequent program codes, a CPU or the like is provided for the function expanding board or unit to execute a part or all of the actual processings, thereby implementing the functions of the above-described embodiment.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of following claims is to be accorded the broadest interpretation so as to encompass all such modifications and equivalent structures and functions.

What is claimed is:

1. An image reader, comprising:
an optical reading section that reads reflected light from a light source;
a first reference density member that is installed outside an original document reading position, and that is read by said optical reading section for acquiring data for correcting shading;
a second reference density member that is fixedly installed at said original document reading position so as not to block the optical path from said light source and the conveyance path of original documents, and that is read by said optical reading section for acquiring data for correcting the light amount of said light source;
a first correction coefficient setting section that sets a first correction coefficient, based on first reference data obtained by reading said first reference density member in advance, and read data obtained by reading said first reference density member at startup of the original document reading;
a second correction coefficient setting section that sets a second correction coefficient for every read page, based on a second reference data obtained by reading said second reference density member in advance, and read data obtained by reading said second reference density member during each time interval between two successive pages of the original documents fed to said original document reading position one page after another while the original documents are read; and
a correction section that performs shading correction according to said first correction coefficient, and that performs light amount correction according to said second correction coefficient corresponding to a read page, for each of the pages of the original document images read by said optical reading section.

2. An image reader according to claim 1, wherein said optical reading section has an photoelectric conversion section that separates reflected light from said light source into a plurality of channels, and that photoelectrically converts the reflected light, and wherein said first correction coefficient setting section sets said first correction coefficient for each of said channels.

3. An image reader according to claim 1, wherein said second correction coefficient setting section sets a correction coefficient common to a plurality of colors.

4. A method for controlling an image reader including an optical reading section that reads reflected light from a light source; a first reference density member that is installed outside an original document reading position, and that is read by said optical reading section for acquiring data for correcting shading; a second reference density member that is fixedly installed at said original document reading position so as not to block the optical path from said light source and a conveyance path of original documents, and that is read by said optical reading section for acquiring data for correcting the light amount of said light source, said method comprising the steps of:
setting a first correction coefficient, based on first reference data obtained by reading said first reference density member in advance, and read data obtained by reading said first reference density member at startup of the original document reading;
setting a second correction coefficient for every read page, based on second reference data obtained by reading said second reference density member in advance, and read data obtained by reading said second reference density member during each time interval between two successive pages of the original documents fed to said original document reading position one page after another while the original documents are read; and
performing shading correction according to said first correction coefficient, as well as performing light amount correction according to said second correction coefficient, for each of the pages of the original document image read by said optical reading section.

5. A method for controlling an image reader according to claim 4, wherein said optical reading section has a photoelectric conversion section that separates reflected light from said light source into a plurality of channels, and that photoelectrically converts the reflected light, and wherein said first correction coefficient setting step sets said first correction coefficient for each of said channels.

6. A method for controlling an image reader according to claim 4, wherein said second correction coefficient setting step sets a correction coefficient common to a plurality of colors.

7. A control program for controlling, by a computer, an image reader including an optical reading section that reads reflected light from a light source; a first reference density member that is installed outside an original document reading position, and that is read by said optical reading section for acquiring data for correcting shading; a second reference density member that is fixedly installed at said original document reading position so as not to block the optical path from said light source and a conveyance path of original documents, and that is read by said optical reading section for acquiring data for correcting the light amount of said light source, said control program comprising the steps of:
setting a first correction coefficient, based on first reference data obtained by reading said first reference density member in advance, and read data obtained by reading said first reference density member at startup of the original document reading;
setting a second correction coefficient for every read page, based on second reference data obtained by reading said second reference density member in advance, and read data obtained by reading said second reference density member during each time interval between two successive pages of the original documents fed to said original document reading position one page after another while the original documents are read; and
performing shading correction according to said first correction coefficient, and performing light amount correction according to said second correction coefficient corresponding a read page, for each of the pages of the original document image read by said optical reading section.

8. A control program for controlling, by a computer, an image reader according to claim 7, wherein said optical reading section has a photoelectric conversion section that separates reflected light from said light source into a plurality of channels, and that photoelectrically converts the reflected light, and wherein said first correction coefficient setting step sets said first correction coefficient for each of said channels.

9. A control program for controlling, by a computer, an image reader according to claim 7, wherein said second correction coefficient setting step sets a correction coefficient common to a plurality of colors.
